(19) United States
(12) Patent Application Publication
(10) Pub. No.: US 2026/0210906 A1
(43) Pub. Date: Jul. 23, 2026

(54) METHOD FOR EVALUATING HYDROGEN GENERATION REACTION

(71) Applicant: NTT, Inc, Tokyo (JP)

(72) Inventors: Takuya Kamisho, Tokyo (JP); Ryuta Ishii, Tokyo (JP); Masayuki Tsuda, Tokyo (JP)

(21) Appl. No.: 19/107,385

(22) PCT Filed: Oct. 14, 2022
(86) PCT No.: PCT/JP2022/038364

§ 371 Date: Feb. 27, 2025

(51) Int. Cl. G01N 27/44

(52) U.S. Cl. CPC G01N 27/44

(57) ABSTRACT

An embodiment is a method for evaluating a hydrogen generation reaction on a steel material includes preparing a steel material saturated with hydrogen. The hydrogen-saturated steel material is immersed in an electrolyte solution containing an additive that promotes hydrogen intrusion. A voltage sweep is applied between the steel material and a reference electrode and a current is measured between the steel material and a counter electrode. Reaction rate coefficients for hydrogen generation reactions are determined based on the measured current.

### CROSS-REFERENCE TO RELATED APPLICATIONS

This application is a national phase entry of PCT Application No. PCT/JP2022/038364, filed on Oct. 14, 2022, which application is hereby incorporated herein by reference.

### TECHNICAL FIELD

The present invention relates to a hydrogen generation reaction assay method.

### BACKGROUND

When high-strength steel material includes hydrogen, it loses ductility and the strength thereof drops significantly. This phenomenon is called hydrogen embrittlement. Regarding such hydrogen embrittlement of steel materials, accelerated hydrogen embrittlement tests have been performed for the purpose of evaluating the hydrogen embrittlement resistance of steel materials and predicting the occurrence of hydrogen embrittlement.

In the accelerated hydrogen embrittlement tests, the cathode charging method in an aqueous solution containing an additive that promotes hydrogen intrusion, such as ammonium thiocyanate, is widely used in order to allow hydrogen to penetrate into the steel material (hydrogen to be absorbed into the steel material). For the cathode charging method, the amount of hydrogen absorbed by the steel material is determined by the hydrogen generation reaction on a surface of the steel material. In the accelerated hydrogen embrittlement tests, evaluations may be performed by changing test conditions. Therefore, evaluating the hydrogen generation reaction under certain test conditions, that is, determining reaction rate coefficients of the Volmer reaction, Heyrovsky reaction, and Tafel reaction, which are hydrogen generation reactions, is used for accurately understanding the hydrogen intrusion into the steel material in the accelerated tests.

As a method for evaluating the hydrogen generation reaction on a surface of a steel material, there is a method using the hydrogen permeation test (see NPL 1). Furthermore, there is a method of evaluating the hydrogen generation reaction on a surface of a steel material by numerical calculation from a polarization curve (see NPL 2).

### CITATION LIST

### Non Patent Literature

[NPL 1] R. N. Iyer et al., “Analysis of Hydrogen Evolution and Entry into Metals for the Discharge-Recombination Process”, Journal of The Electrochemical Society, vol. 136, No. 9, 1989.
[NPL 2] Maria R. et al., “Hydrogen evolution reaction on a smooth iron electrode in alkaline solution at different temperatures”, Physical Chemistry Chemical Physics, vol. 3, No. 15, pp. 3180-3184, 2001.

### SUMMARY

### Technical Problem

The method of evaluating the hydrogen generation reaction on a surface of a steel material using the hydrogen permeation test is limited to thin plate-shaped steel materials. Therefore, this assay method is unable to be applied to rod-shaped steel materials. The method described in NPL 2 is limited to cases where hydrogen intrusion into a steel material is very small, such as cathodic charging in an aqueous solution to which no additives that promote hydrogen intrusion are added. Evaluation (measurement) of the hydrogen generation reaction on the surface of the steel material in the environment of an accelerated hydrogen embrittlement test is carried out in an aqueous solution containing an additive that promotes hydrogen intrusion. In this measurement environment, the steel material is in a state where it is attempting to absorb a large amount of hydrogen, so it is not possible to accurately measure (evaluate) the hydrogen generation reaction on the surface of the steel material. As described above, the conventional approach has the challenge that it is not possible to accurately evaluate the hydrogen generation reaction on the surface of the steel material in the environment of the accelerated hydrogen embrittlement test for rod-shaped steel materials.

Embodiments of the present invention are made to address the challenge mentioned above, and an object of embodiments of the present invention are to accurately evaluate the hydrogen generation reaction on the surface of the steel material in the environment of the accelerated hydrogen embrittlement test for rod-shaped steel materials.

### Solution to Problem

A hydrogen generation reaction assay method according to embodiments of the present invention includes: a first step of charging hydrogen into a steel material to be evaluated until the hydrogen storage capacity is saturated; a second step of immersing the steel material with a saturated amount of hydrogen storage, a reference electrode, and a counter electrode in an electrolyte solution containing an additive that promotes hydrogen intrusion into the steel material, and then measuring a change in a current flowing between the steel material and the counter electrode when sweeping a voltage between the steel material and the reference electrode, the steel material serving as a working electrode; and a third step of evaluating a hydrogen generation reaction on a surface of the steel material based on the measured change in the current.

### Advantageous Effects

As stated above, according to embodiments of the present invention, hydrogen generation in the steel material is measured after the steel material to be evaluated is charged with hydrogen until the hydrogen storage capacity is saturated, and thus it is possible to accurately evaluate the hydrogen generation reaction on the surface of the steel material in the environment of an accelerated hydrogen embrittlement test for rod-shaped steel materials.

### BRIEF DESCRIPTION OF THE DRAWINGS

FIG. 1 is a flowchart illustrating a hydrogen generation reaction assay method according to an embodiment of the present invention.

FIG. 2 is a configuration diagram illustrating a configuration of a measuring system for implementing the hydrogen generation reaction assay method according to an embodiment of the present invention.

FIG. 3 is a characteristic diagram illustrating a polarization curve obtained as a result of the actual measurement.

FIG. 4 is a configuration diagram illustrating a configuration example of a device for hydrogen charging in the hydrogen generation reaction assay method according to an embodiment of the present invention.

### DETAILED DESCRIPTION OF ILLUSTRATIVE EMBODIMENTS

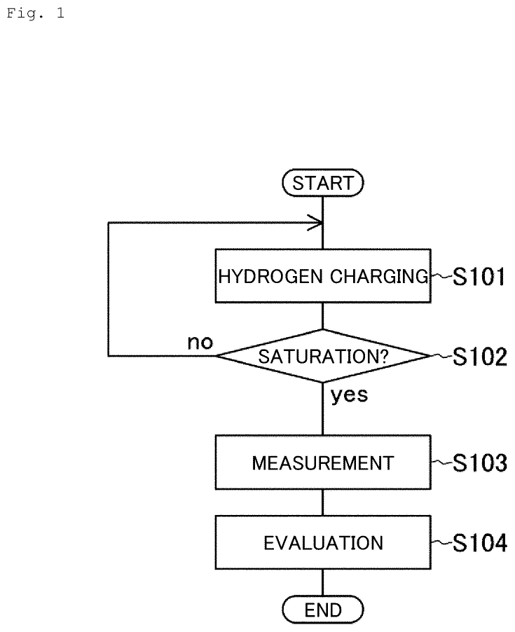

Hereinafter, the hydrogen generation reaction assay method according to an embodiment of the present invention will be described with reference to FIG. 1.

First, in step S101, the steel material to be evaluated is charged with hydrogen until the hydrogen storage capacity is saturated (step S102) (first step). For example, a steel material can be charged with hydrogen by a cathodic hydrogen charging method using an electrolyte solution containing an additive that promotes hydrogen intrusion (absorption) into the steel material.

In step S103, the steel material with a saturated amount of hydrogen storage, a reference electrode, and a counter electrode are immersed in an electrolyte solution containing an additive that promotes hydrogen intrusion into the steel material, followed by measuring a change in a current flowing between the steel material and the counter electrode when sweeping a voltage between the steel material and the reference electrode (second step). The steel material serves as a working electrode.

In step S104, a hydrogen generation reaction is evaluated on a surface of the steel material based on the measured change in the current (third step). For example, a reaction rate coefficient of the hydrogen generation reaction may be determined based on the measured change in the current, and the hydrogen generation reaction on the surface of the steel material may be evaluated from the determined reaction rate coefficient.

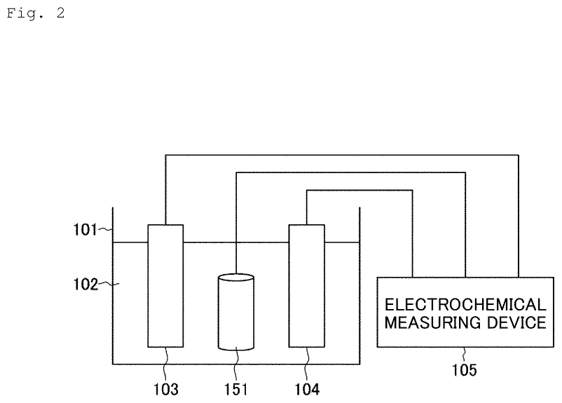

As shown in FIG. 2, a measuring system for implementing the hydrogen generation reaction assay method may include a container 101 made of, for example, acrylic resin, and an electrolyte solution 102 contained in the container 101. The electrolyte solution 102 is, for example, a 1 mol/L aqueous sodium hydrogen carbonate solution, and an additive that promotes hydrogen intrusion is added thereto. The additive may be ammonium thiocyanate. For example, 0.1 mol/L of ammonium thiocyanate may be added to a 1 mol/L aqueous sodium hydrogen carbonate solution (electrolyte solution 102). Note that the additive is not limited to ammonium thiocyanate, and may be, for example, sodium sulfide (Na2S) or calcium phosphide (Ca3P2).

Further, this measuring system includes a reference electrode 103 and a counter electrode 104, immersed in the electrolyte solution 102. The reference electrode 103 is, for example, an Ag/AgCl (silver/silver chloride) electrode, and the counter electrode 104 is a Pt electrode. Further, a piece of steel material 151 serving as a working electrode is immersed in the electrolyte solution 102. For example, the steel material 151 has a rod shape with a diameter of 7.2 mm, a length of 30 mm and a circular cross section. The reference electrode 103, the counter electrode 104, and the steel material 151 are connected to an electrochemical measuring device 105 via wiring. The electrochemical measuring device 105 is, for example, a potentiostat.

By using this measuring system, hydrogen charging can be performed. A three-electrode configuration can be adopted in which the steel material 151 serving as the working electrode, the reference electrode 103 and the counter electrode 104 are provided, the temperature of the electrolyte solution 102 is 30° C., and a cathode charging current density for the steel material 151 is 10 A/m2. Note that these conditions are electrochemical conditions in which the surface of the steel material 151 in contact with the electrolyte solution 102 does not corrode. By cathodic charging in this manner, hydrogen is generated on the surface of the steel material 151. Accordingly, hydrogen is occluded (absorbed) in the steel material 151. In this way, the cathodic hydrogen charging method enables that hydrogen is generated on the surface of the steel material 151 and then occluded (absorbed) in the steel material 151. By performing cathode charging for 72 hours under the conditions stated above, the amount of hydrogen stored in the steel material 151 can be brought to that of a saturated state.

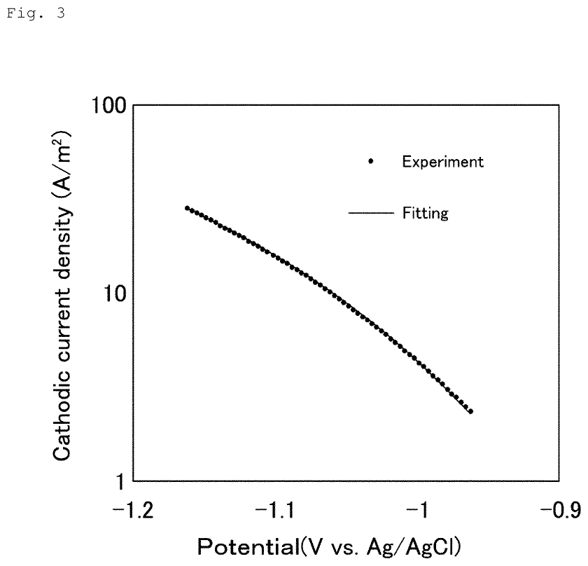

As described above, when the amount of hydrogen occluded in the steel material is brought to a saturated state (first step), the change in the current is immediately measured in the second step (polarization curve measurement). A range in which the voltage applied between the steel material and the reference electrode is swept is from the natural potential to −1.2 V vs. Ag/AgCl, and the scanning speed of the voltage is 20 mV/min. By measuring this polarization curve, the polarization curve shown in FIG. 3 is obtained.

The hydrogen generation reaction is evaluated for the obtained polarization curve using a well-known numerical calculation (NPL 2). If the reaction rate coefficients of the Volmer reaction, Heyrovsky reaction, and Tafel reaction, which are hydrogen generation reactions, are k1, k2, and k3, respectively, the cathode charge current density i_{c} can be expressed by the following formula using k1, k2, and k3. In the formula, F denotes Faraday's constant.

$${i}_{c} = F {k}_{1} + F ( {k}_{2} - {k}_{1} ) \frac{- ( {k}_{1} + {k}_{2} ) + \sqrt{{( {k}_{1} + {k}_{2} )}^{2} + 8 {k}_{1} {k}_{3}}}{4 {k}_{3}} \qquad [ Math . 1 ]$$

Further, k1 and k2 in the above formula can be expressed by the following formula using the potential E. Here, k1′ is k1 when E=0, k2′ is k2 when E=0, a is the charge transfer coefficient (=0.5), R is the gas constant, and T is the absolute temperature.

$${k}_{1} = {k}_{1}^{′} exp ( \frac{- α F E}{R T} ) \qquad [ Math . 2 ]$$

$${k}_{2} = {k}_{2}^{′} exp ( \frac{- α F E}{R T} )$$

Values of k1, k2, and k3 may be determined by fitting the formula of the cathode charge current density i_{c} expressed using k1, k2, and k3 to the polarization curve using the least squares method. The fitting range may be ±100 mV centered on the potential when the cathode charge current density is 10 A/m2.

The solid line in FIG. 3 shows the fitting results. k1, k2, and k3 at the cathode charge current density of 10 A/m2 were calculated as 1.7×10-4, 1.3×10-8, and 3.2×10-4, respectively, and the hydrogen generation reaction on the surface of the steel material was evaluated when performing the accelerated hydrogen embrittlement test.

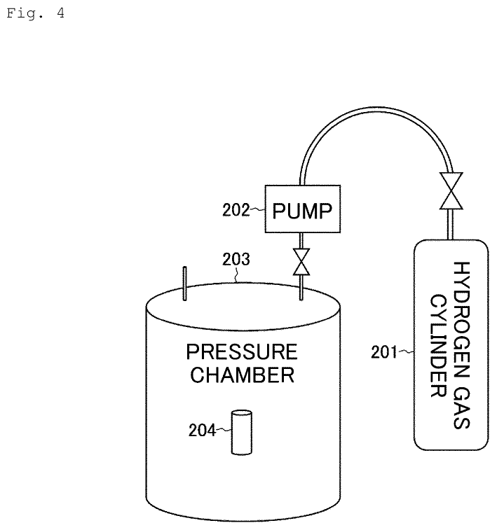

In the first step of the embodiment above, hydrogen is electrochemically (cathode-charging) occluded in the steel material using the additive that promotes hydrogen intrusion, such as ammonium thiocyanate, but the method is not limited thereto. In the first step, the steel material may be charged with hydrogen by placing the steel material in a hydrogen atmosphere. For example, as shown in FIG. 4, hydrogen supplied from a hydrogen gas cylinder 201 is pumped with a pump 202 to place a round steel bar 204 to be measured for a certain period of time inside a pressure chamber 203 in a high-pressure hydrogen environment (hydrogen atmosphere with a pressure higher than atmospheric pressure), it is possible to allow the steel material to occlude hydrogen until it is saturated with hydrogen.

As stated above, according to embodiments of the present invention, hydrogen generation in the steel material is measured after the steel material to be evaluated is charged with hydrogen until the hydrogen storage capacity is saturated, thus it is possible to accurately evaluate the hydrogen generation reaction on the surface of the steel material in the environment of an accelerated hydrogen embrittlement test for rod-shaped steel materials.

Some or all of the embodiments are also described in the following supplements, but are not limited to the following.

### [Supplement 1]

A hydrogen generation reaction assay method, including: a first step of charging hydrogen into a steel material to be evaluated until the hydrogen storage capacity is saturated; a second step of immersing the steel material with a saturated amount of hydrogen storage, a reference electrode, and a counter electrode in an electrolyte solution containing an additive that promotes hydrogen intrusion into the steel material, and then measuring a change in a current flowing between the steel material and the counter electrode when sweeping a voltage between the steel material and the reference electrode, the steel material serving as a working electrode; and a third step of evaluating a hydrogen generation reaction on a surface of the steel material based on the measured change in the current.

### [Supplement 2]

The hydrogen generation reaction assay method as set forth in Supplement 1, wherein the additive is ammonium thiocyanate.

### [Supplement 3]

The hydrogen generation reaction assay method as set forth in Supplement 1 or 2, wherein the steel material is charged with hydrogen by a cathodic hydrogen charging method using the electrolyte solution in the first step.

### [Supplement 4]

The hydrogen generation reaction assay method as set forth in Supplement 1 or 2, wherein the steel material is charged with hydrogen by placing the steel material in a hydrogen atmosphere in the first step.

### [Supplement 5]

The hydrogen generation reaction assay method as set forth in Supplement 4, wherein the steel material is charged with hydrogen by placing the steel material in a hydrogen atmosphere at a pressure higher than atmospheric pressure in the first step.

### [Supplement 6]

The hydrogen generation reaction assay method as set forth in any one of Supplement 1 to 5, wherein a reaction rate coefficient of the hydrogen generation reaction is determined based on the measured change in the current, and the hydrogen generation reaction on the surface of the steel material is evaluated from the determined reaction rate coefficient in the third step.

Note that it is clear that the present invention is not limited to the embodiments described above, and that within the technical concept of the present invention, many modifications and combinations can be implemented by those skilled in the art.

### REFERENCE SIGNS LIST

101 Container
102 Electrolyte solution
103 Reference electrode
104 Counter electrode
105 Electrochemical measuring device
151 Steel material

1-6. (canceled)

7. A hydrogen generation reaction assay method, comprising:
charging hydrogen into a steel material to be evaluated until a hydrogen storage capacity is saturated;
immersing the steel material with a saturated amount of hydrogen storage, a reference electrode, and a counter electrode in an electrolyte solution containing an additive that promotes hydrogen intrusion into the steel material, and then measuring a change in a current flowing between the steel material and the counter electrode when sweeping a voltage between the steel material and the reference electrode, the steel material serving as a working electrode; and
evaluating a hydrogen generation reaction on a surface of the steel material based on the measured change in the current.

8. The hydrogen generation reaction assay method according to claim 7, wherein the additive is ammonium thiocyanate.

9. The hydrogen generation reaction assay method according to claim 7, wherein charging hydrogen into the steel material comprises using a cathodic hydrogen charging method with the electrolyte solution.

10. The hydrogen generation reaction assay method according to claim 7, wherein charging hydrogen into the steel material comprises placing the steel material in a hydrogen atmosphere.

11. The hydrogen generation reaction assay method according to claim 10, wherein the hydrogen atmosphere is at a pressure higher than atmospheric pressure.

12. The hydrogen generation reaction assay method according to claim 7, wherein evaluating the hydrogen generation reaction comprises:
determining a reaction rate coefficient of the hydrogen generation reaction based on the measured change in the current; and
evaluating the hydrogen generation reaction on the surface of the steel material from the determined reaction rate coefficient.

13. The hydrogen generation reaction assay method according to claim 7, wherein the steel material has a rod shape.

14. The hydrogen generation reaction assay method according to claim 7, wherein the electrolyte solution comprises a 1 mol/L aqueous sodium hydrogen carbonate solution.

15. The hydrogen generation reaction assay method according to claim 7, wherein the reference electrode is an Ag/AgCl electrode and the counter electrode is a Pt electrode.

16. The hydrogen generation reaction assay method according to claim 7, wherein charging hydrogen into the steel material comprises charging for 72 hours.

17. The hydrogen generation reaction assay method according to claim 7, wherein sweeping the voltage comprises sweeping from a natural potential to −1.2 V vs. Ag/AgCl at a scanning speed of 20 mV/min.

18. The hydrogen generation reaction assay method according to claim 7, wherein evaluating the hydrogen generation reaction comprises:
determining reaction rate coefficients of a Volmer reaction, a Heyrovsky reaction, and a Tafel reaction based on the measured change in the current; and
evaluating the hydrogen generation reaction on the surface of the steel material using the determined reaction rate coefficients.

19. The hydrogen generation reaction assay method according to claim 18, wherein determining the reaction rate coefficients comprises fitting a formula of cathode charge current density to a polarization curve using a least squares method.

20. A method for evaluating a hydrogen generation reaction on a steel material, comprising:
preparing a steel material saturated with hydrogen;
immersing the hydrogen-saturated steel material in an electrolyte solution containing an additive that promotes hydrogen intrusion;
applying a voltage sweep between the steel material and a reference electrode while measuring a current between the steel material and a counter electrode; and
determining reaction rate coefficients for hydrogen generation reactions based on the measured current.

21. The method of claim 20, wherein preparing the steel material saturated with hydrogen comprises charging hydrogen into the steel material using a cathodic hydrogen charging method.

22. The method of claim 20, wherein preparing the steel material saturated with hydrogen comprises exposing the steel material to a high-pressure hydrogen atmosphere.

23. The method of claim 20, wherein the additive is ammonium thiocyanate.

24. The method of claim 20, wherein determining the reaction rate coefficients comprises:
fitting a formula of cathode charge current density to a polarization curve obtained from the measured current; and
calculating reaction rate coefficients for Volmer, Heyrovsky, and Tafel reactions.

25. The method of claim 20, wherein the voltage sweep is performed from a natural potential to −1.2 V vs. Ag/AgCl at a scanning speed of 20 mV/min.

26. The method of claim 20, wherein the steel material has a rod shape.
